(19) United States
(12) Patent Application Publication
(10) Pub. No.: US 2016/0209732 A1
(43) Pub. Date: Jul. 21, 2016

(54) Camera Supporting and Stabilization Apparatus and Methods

(71) Applicant: Yong Liang, San Francisco, CA (US)

(72) Inventor: Yong Liang, San Francisco, CA (US)

(21) Appl. No.: 14/601,235

(22) Filed: Jan. 21, 2015

(51) Int. Cl. G03B 17/56; G05B 15/02

(52) U.S. Cl. CPC G03B 17/561; G03B 17/563; G05B 15/02

(57) ABSTRACT

Apparatus and methods for keeping cameras and video recorders stable are disclosed herein. The apparatus and methods disclose a multifunctional dual-armed stabilizing system for augmenting the capabilities of equipment-stabilizing supports for camera or video recorders. Techniques are disclosed about a vertical grip tri-axial gyro electronic stabilizer that can actively adjust the motors and stabilize the camera and video recorders. A method of dynamically stabilizing a camera is also disclosed.

### FIELD OF THE INVENTION

At least one embodiment of the present invention pertains to a multifunctional dual-armed stabilizing system for camera. At least one embodiment of the present invention pertains to a multifunctional dual manipulator arm vest. At least one embodiment of the present invention pertains to a method to support and stabilize a camera or a video recorder. At least one embodiment of the present invention has following beneficial effects that a user can use this multifunctional dual-armed stabilizing system for holding a camera or a video recorder for a long time without fatigue by transferring the weight from his/her hands and arms to his/her waist and back, thus to make sure the camera or video recorder keep stabilized.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

This invention relates to a mechanism for stabilizing a video device or a camera and reducing vibrations caused by movements by a user. Hand-held video cameras are popular instruments to make movies. However, the picture quality can be unsatisfactory due to tremors and jitters in the user's hand when holding the camera. Same issues can occur for professional camera or video recorders because they are heavier. Therefore, there exists a need to minimize unwanted camera motion, which tends to occur when an operator moves a video camera or other motion picture camera during operation.

Currently, the existing hand-held electronic gyro stabilizer is suffering a serious issue. A user can easily suffer fatigues to his/her body and arms. The fatigues are caused by a long duration of holding the video equipment. Furthermore, the fatigues can weaken the stability of the video platform significantly, affecting the quality of the video shooting.

Existing Steadicam Stabilizer (STEADICAM) is suitable for single-handed operation, but not suitable for applications that both hands of a user are needed to grip the system. The electronic gyro stabilizer's spring arm is so large and caught in the middle of the photographer's arms, that the spring cannot be very effective to reduce vibration. In addition, dual-spring system has a very heavy weight, causing a large burden on the photographer and fatigues to his/her body and arms.

Therefore, a need therefore exists for an apparatus for augmenting the capabilities of equipment-stabilizing supports—in particular body-mounted camera stabilizers—and extending their reach and angular agility so that stabilized operations, such as shots, can be made that preferably include unrestricted and intuitive angular control of the camera, as well as large lateral and vertical displacements from the operator's position. Moreover, a camera supporting system can ease the pressure on the arm and serve the purpose of a long and stable video shooting. At the same time, the size of the equipment should be smaller enough for a single person to use and can enable the photographer to move freely and does not affect the normal operation. Furthermore, the system should be able to reduce vibration significantly and achieve stable video shooting because there will be vibrations transmitted to the camera when the photographer moves.

### SUMMARY

Techniques introduced here provide a multifunctional dual-armed stabilizing system for augmenting the capabilities of equipment-stabilizing supports for camera or video recorders. In some embodiments, the multi-functional apparatus comprises a nylon surface sponge cushioning vest, and the nylon surface sponge cushioning vest comprises an adjustable shoulder belt, an adjustable chest belt, and an adjustable waist belt.

In some embodiments, the multifunctional dual-armed stabilizing system comprises a lower metal panel coupled to the nylon surface sponge cushioning vest, and the lower metal panel covers at least a portion of a user's waist.

In some embodiments, the multifunctional dual-armed stabilizing system comprises a metal height adjustment plate coupled to the nylon surface sponge cushioning vest and an upper metal panel coupled to the nylon surface sponge cushioning vest. The upper metal panel covers at least a portion of the user's back.

In some embodiments, the multifunctional dual-armed stabilizing system comprises a metal folding arms mount coupled to the nylon surface sponge cushioning vest and a lower group of metal folding arms coupled to the metal folding arm mount via a lower holding shaft, and the lower group of metal folding arms comprises two folding arms, and a metal limiting panel coupled between the two folding arms.

In some embodiments, the multifunctional dual-armed stabilizing system comprises an upper group of metal folding arms, coupled to the lower group of metal folding arms via an upper folding shaft, and the upper group of metal folding arms comprises another two metal folding arms, and the another two metal folding arms comprises at least two sling installation modules.

Major advantages of the multifunctional dual-armed stabilizing system are as following. First, the system comprises the L-shaped double arm bracket structure and can effectively transfer the heavy weight from the arm to the waist and the back of a user. This design can effectively reduce a user's fatigue. Second, both arms can be folded twice and can be removed according to requirements from a user. This design can effectively reduce the size of the platform. Third, the platform uses one or more elastic sling suspension and vibration-reduction structure to keep the platform stable even when the user is moving. Fourth, other accessories can be installed in the front of the arms and enable the platform to be very versatile.

Techniques introduced here also provide an electronic gyro stability control system that comprises a grip handle that is configured to be held by a single hand that comprises a rechargeable battery, a charging jack for the rechargeable battery and a power switch button. In some embodiments, the electronic gyro stability control system also comprises a rotation motor coupled to the grip handle and the rotation motor is configured to adjust direction of the electronic gyro stability control system. The electronic gyro stability control system also comprises an L-shaped supporting structure coupled to the rotation motor and controlling circuits sit within the L-shaped supporting structure. The controlling circuits are configured to control the rotation motor and the L-shaped supporting structure comprises a first arm and a second arm. The first arm of the L-shaped supporting structure is coupled to the rotation motor.

In some embodiments, the electronic gyro stability control system also comprises a roll motor coupled to the L-shaped supporting structure via the second arm of the L-shaped supporting structure. The roll motor is configured to enable adjustments of horizontal position of an installed camera and the controlling circuits are configured to control the roll motor.

In some embodiments, the electronic gyro stability control system also comprises a roll arm attached to the roll motor, wherein the roll arm is driven by the roll motor to stabilize the horizontal position of the installed camera. A first controller coupled to the roll arm and the first controller is configured to stabilize horizontal gravity center of the electronic stability control system with the installed camera.

In some embodiments, the electronic gyro stability control system also comprises a tilt motor coupled to the roll arm and the tilt motor is configured to enable adjustments of tilting angle of the installed camera. The tilt motor is configured to stabilize the installed camera within a predetermined tilting angle and the controlling circuits are configured to control the tilt motor.

In some embodiments, the electronic gyro stability control system also comprises a second controller coupled to the tilt motor and the second controller is configured to stabilize vertical gravity center of the electronic stability control system with the installed camera.

In some embodiments, the electronic gyro stability control system also comprises a base plate coupled to the second controller, wherein the base plate is configured to attach the installed camera.

In some embodiments, the electronic gyro stability control system also comprises a sensor coupled to the base plate and the sensor sends information of angle and angular acceleration of the installed camera to the controlling circuits. The controlling circuits dynamically control the rotation motor, the roll motor and the tilt motor to realize stability of electronic gyro stability control system with the installed camera.

In some embodiments, the electronic gyro stability control system also provides a stabilizing mechanism and can reduce vibration significantly when the user moves. Furthermore, due to the use of electronic controls, the system can extend the stabilizer's electronic applications, such as a wireless remote control. The remote control can adjust the rotation in three axes, along with a Bluetooth mobile phone to adjust the parameters. Therefore, a user can easily adjust the three-axis movements by using parameter adjustments in a three-axis motion remote control handset.

Techniques introduced here also provide a method stabilizing a camera. The method comprises several steps. In some embodiments, the method comprises balancing gravity center of a stability control system with an installed camera coupled to the stability control system and obtaining information of angle and angular acceleration of the installed camera via a three-axis accelerometer coupled to a three-axis gyroscope.

In some embodiments, the method comprises passing the information of the angle and the angular acceleration of the installed camera to a microcontroller and sending one or more commands from the microcontroller to a rotation motor, a roll motor and a tilt motor. The commands are sent via wireless connections. The one or more commands are determined by the microcontroller based on the information of the angle and the angular acceleration of the installed camera and pre-determined programs stored in the microcontroller.

In some embodiments, the method comprises controlling tilt angle of the installed camera and stabilizing the installed camera within a pre-determined tilt angle via the tilt motor based on a first set of the one or more commands and stabilizing horizontal position of the installed camera via the roll motor based on a second set of the one or more commands.

In some embodiments, the method comprises stabilizing vertical position of the installed camera and a grip handle via the rotation motor based on a third set of the one or more commands. The grip handle is configured to be held by a single hand and the grip handle comprises a rechargeable battery, a charging jack for the rechargeable battery and a power switch button.

Other aspects of the technology introduced here will be apparent from the accompanying figures and from the detailed descriptions which follow.

### BRIEF DESCRIPTION OF THE DRAWINGS

These and other objects, features and characteristics of the present invention will become more apparent to those skilled in the art from a study of the following detailed description in conjunction with the appended claims and drawings, all of which form a part of this specification. In the drawings:

FIG. 1 illustrates a diagram of a multifunctional dual-armed stabilizing system for cameras or video recorders in side view.

FIG. 2 illustrates a diagram of a multifunctional dual-armed stabilizing system for cameras or video recorders in front view.

FIG. 3 illustrates a diagram of a multifunctional dual-armed stabilizing system for cameras or video recorders with two slings.

FIG. 4 illustrates a diagram of a multifunctional dual-armed stabilizing system for cameras or video recorders with a single sling.

FIG. 5 illustrates a diagram of a multifunctional dual-armed stabilizing system for cameras or video recorders in bottom view.

FIG. 6 illustrates a diagram of a multifunctional dual-armed stabilizing system for cameras or video recorders in a first-degree folded position.

FIG. 7 illustrates a diagram of a multifunctional dual-armed stabilizing system for cameras or video recorders in a second-degree folded position.

FIG. 8 illustrates a diagram of a multifunctional dual-armed stabilizing system for cameras or video recorders in a third-degree folded position.

FIG. 9 illustrates a diagram of an electronic gyro stability control system that can be held by a single hand.

FIG. 10 illustrates a block diagram illustrating an example of components and their interactions in an electronic gyro stability control system that can be held by a single hand.

FIG. 11 illustrates a flow diagram illustrating an example process of dynamically stabilizing a camera.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “some embodiments” or “an embodiment” means that a particular feature, structure, or characteristic described in connection with the embodiment is included in at least one embodiment of the disclosure. The appearances of the phrase “in some embodiments” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

In the recent years, gyro stabilizers fundamentally solve the issue of keeping camera stable when the photographer is moving. However, original electronic gyro stabilizers also brought new problems. The photographer needs to hold the electronic gyro-stabilizer for a long time and the weight of the electronic gyro-stabilizer and the camera causes fatigues to the photographer. Therefore, there are needs for an auxiliary supporting system that can ease the pressure on the arms of the photographer and realize the purpose of a long and stable shooting. At the same time the system should be able to reduce vibration during the movement of the photographer.

Furthermore, in recent years, three-axis gyroscope and three-axis acceleration sensor become more popular. Brushless motors have gone through significant development. Microcontrollers are also being used to control different kinds of systems. All these technological development enable the hand-held camera stabilizing system to dramatically balance itself up to several hundred times per second. Vertical grip tri-axial gyro electronic stabilizer has greater benefits that it is integrated, compact, easy to use and portable, fully functional, can be installed in a traditional tripod, a monopod or any other supporting structures. A person can use mobile phone or a separate remote control for wireless remote control, which greatly expanded the usage of the system. In addition to holding upright, a user can also hold the system upside down and realize low-angle shooting. Due to the use of electronic controls, such as with a wireless remote control, a user can remotely control the three axes of rotation, along with a BLUETOOTH connected mobile phone to adjust the parameters, so that the effect can be transformed by the use of parameter adjustment. Furthermore, the three-axis motion can also be remotely controlled by a handset or smart phone.

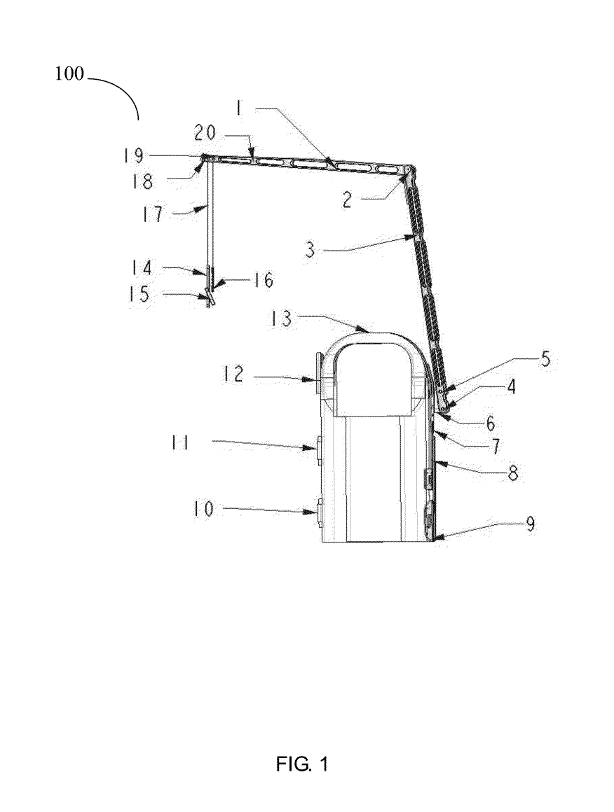

FIG. 1 illustrates a diagram of a multifunctional dual-armed stabilizing system 100 for cameras or video recorders in side view. In some embodiments, the multifunctional dual-armed stabilizing system 100 comprises a nylon surface sponge cushioning vest 13, and the nylon surface sponge cushioning vest 13 comprises an adjustable shoulder belt 12, an adjustable chest belt 11, and an adjustable waist belt 10.

In some embodiments, the multifunctional dual-armed stabilizing system 100 comprises a lower metal panel 9 coupled to the nylon surface sponge cushioning vest 13, and the lower metal panel 9 covers at least a portion of a user's waist.

In some embodiments, the multifunctional dual-armed stabilizing system 100 comprises a metal height adjustment plate 8 coupled to the nylon surface sponge cushioning vest 13 and an upper metal panel 7 coupled to the nylon surface sponge cushioning vest 13. The upper metal panel covers at least a portion of the user's back.

In some embodiments, the multifunctional dual-armed stabilizing system 100 comprises a metal folding arms mount 5 coupled to the nylon surface sponge cushioning vest 13 and a lower group of metal folding arms 3 coupled to the metal folding arm mount 5 via a lower holding shaft 4 and a folding arm fixture 6, and the lower group of metal folding arms 3 comprises two folding arms, and a metal limiting panel 21 coupled between the two folding arms.

In some embodiments, the multifunctional dual-armed stabilizing system 100 comprises an upper group of metal folding arms 1, coupled to the lower group of metal folding arms 3 via an upper folding shaft 2, and the upper group of metal folding arms 1 comprises another two metal folding arms, and the another two metal folding arms comprises at least two sling installation modules 18.

In some embodiments, the multifunctional dual-armed stabilizing system 100 further comprises two slings 17 and two slings 17 are connected to two sling installation modules 18 via two metal locking mechanisms 19 individually. In some embodiments, the slings can move smoothly and can be adjusted by the user.

In some embodiments, inside the multifunctional dual-armed stabilizing system 100, the two slings 17 are configured to be elastic and the two slings 17 can be nylon rope or metal spring rope.

In some embodiments, inside the multifunctional dual-armed stabilizing system 100, the upper group of metal folding arms 1 comprises a microphone and an installation module 20 for a lamp and the installation module 20 comprises multiple installation holes. In some embodiments, accessories and extension brackets can be installed on the installation module, pending on needs from a user. In some embodiments, the two slings 17 comprise a metal hook 14 and a metal hook locking mechanism 16 and the metal hook 16 comprises a hook safety lock 15.

In some embodiments, inside the multifunctional dual-armed stabilizing system 100, the upper group of metal folding arms 1 is configured to rotates 270 degrees in a clockwise direction via the at least one folding shaft to form a uniformed structure with the lower group of metal folding arms 3.

In some embodiments, inside the multifunctional dual-armed stabilizing system 100, the two slings 17 are made of rubber or nylon or a metallic material and the two slings 17 are configured to suspend objects. In some embodiments, inside the multifunctional dual-armed stabilizing system 100, the lower folding shaft 4 is configured to be removable.

In some embodiments, inside the multifunctional dual-armed stabilizing system 100, the multifunctional dual-armed stabilizing system 100 is configured to hold a video camera. In other examples, the multifunctional dual-armed stabilizing system 100 can be configured to hold multiple microphones and other instruments.

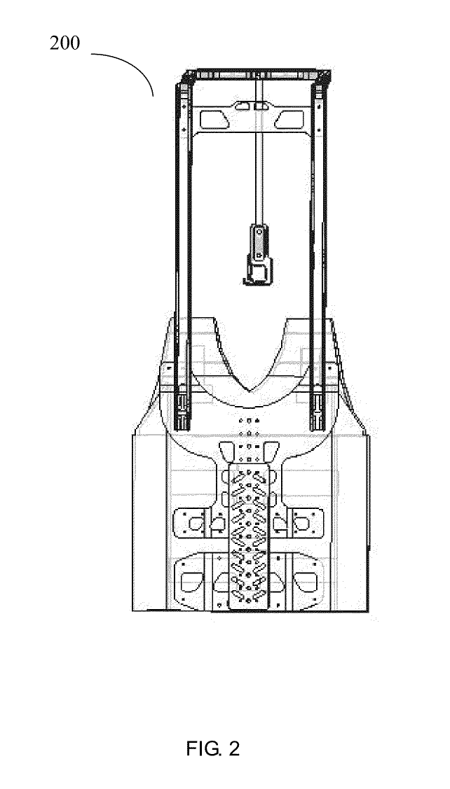

FIG. 2 illustrates a diagram of the multifunctional dual-armed stabilizing system 200 for cameras or video recorders but in front view. The structures and functionality would be as same as the multifunctional dual-armed stabilizing system 100 in FIG. 1.

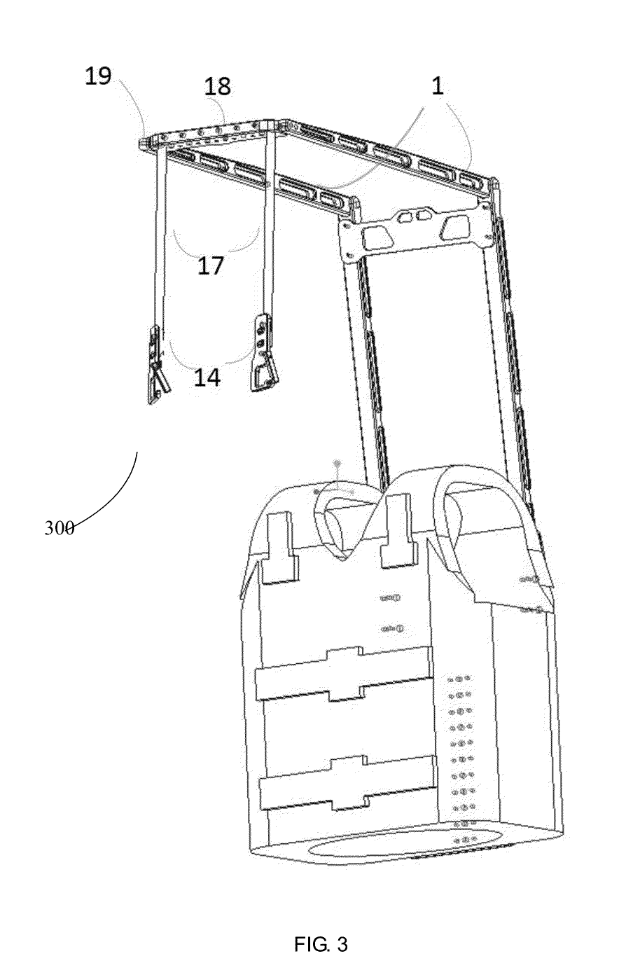

FIG. 3 illustrates a diagram of a multifunctional dual-armed stabilizing system for cameras or video recorders with two slings. Inside the multifunctional dual-armed stabilizing system, the upper group of metal folding arms 1 couple to sling installation module 18. There are two slings 17 coupled to the sling installation module 18. The two slings 17 are coupled to the sling installation module 18 via two metal locking mechanisms 19. Two metal hooks 14 are coupled to the front of the two slings 17.

When in use, an electronic gyro stability control system can be attached to the metal hooks 14. A user only needs to use both hands to control direction of the platform without being burdened by the weight of the electronic gyro stability control system and the cameras. This design significantly reduces the burden on the user and reduces the fatigues to the arms of the user, therefore, enabling the user to shoot videos for a long duration.

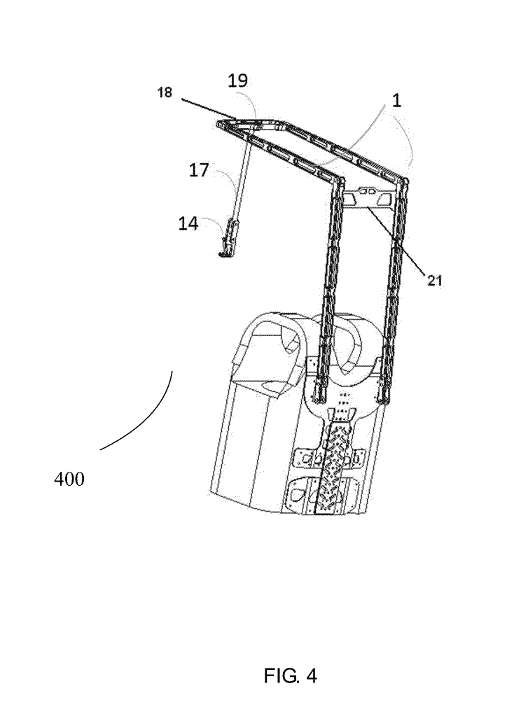

FIG. 4 illustrates a diagram of a multifunctional dual-armed stabilizing system 400 for cameras or video recorders with a single sling 17. Inside the multifunctional dual-armed stabilizing system 400, the upper group of metal folding arms 1 couple to sling installation module 18. There is a single sling 17 coupled to the sling installation module 18. The single sling 17 couples to the sling installation module 18 via two metal locking mechanisms 19. A metal hook 14 is coupled to the front of the single sling 17.

When in use, an electronic gyro stability control system can be attached to the metal hook 14. A user only needs to use both hands to control direction of the platform without being burdened by the weight of the electronic gyro stability control system and the cameras. This design significantly reduces the burden on the user and the fatigues to the arms of the user, therefore, enabling the user to shoot videos for a long duration.

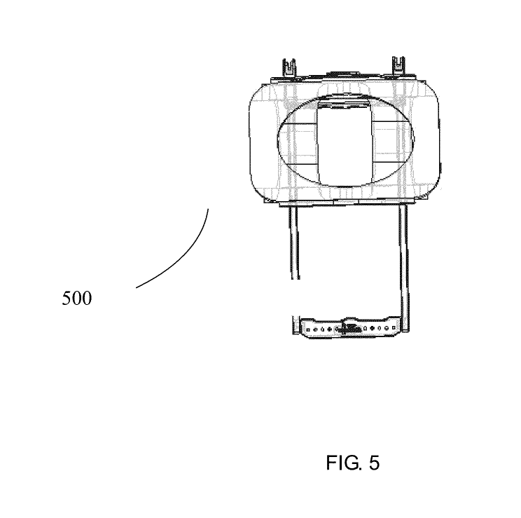

FIG. 5 illustrates a diagram of a multifunctional dual-armed stabilizing system 500 for cameras or video recorders in bottom view. The structures and functionality would be as same as the multifunctional dual-armed stabilizing system 400 in FIG. 4.

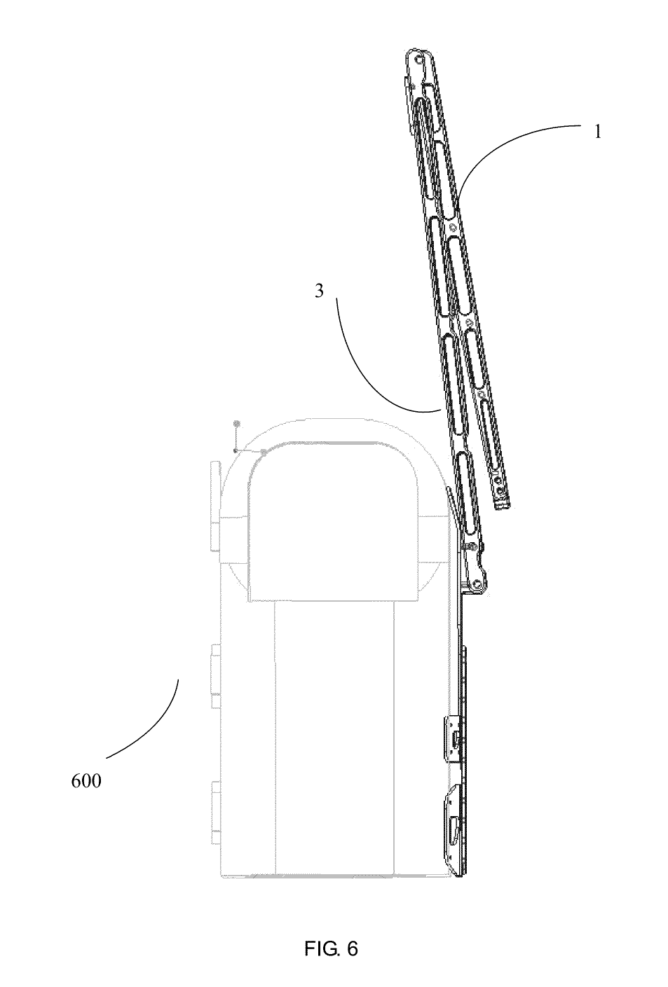

In some embodiments, a multifunctional dual armed stabilizing system is very versatile and can be folded in different ways shown in FIG. 6-8.

FIG. 6 illustrates a diagram of a multifunctional dual-armed stabilizing system for cameras or video recorders in a first-degree folded position. The upper group of metal folding arms 1 is configured to rotate 270 degree in a clockwise direction via the at least one folding shaft to form a uniformed structure with the lower group of metal folding arms 3. The setup in FIG. 6 can reduce the overall size of the system and is very convenient for a user when he/she has not ready to use the dual arms to attach electronic gyro stability control system and the cameras.

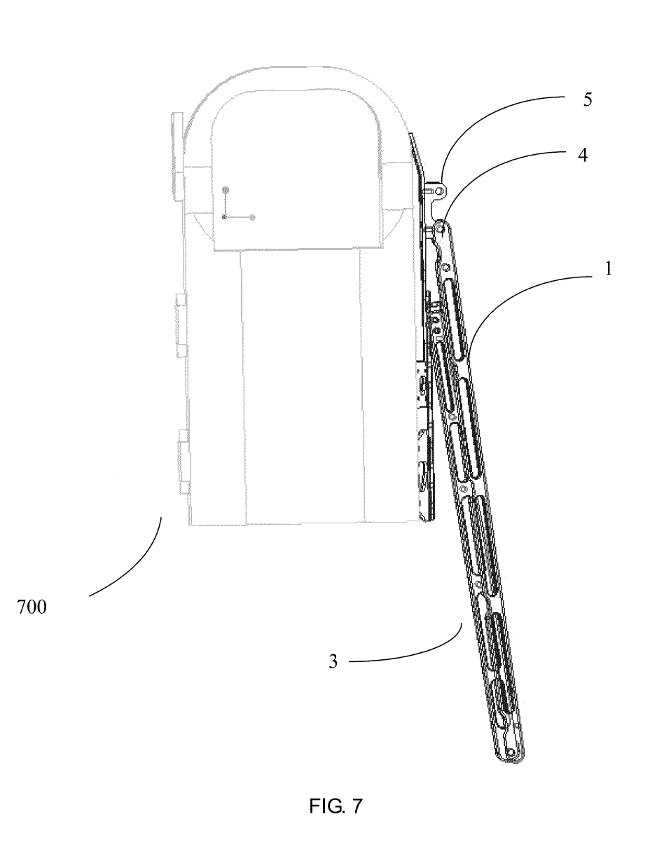

FIG. 7 illustrates a diagram of a multifunctional dual-armed stabilizing system 700 for cameras or video recorders in a second-degree folded position. At the basis of the first-degree folded position, a user can unlock a metal folding arms mount 5 and rotate the lower group of metal folding arms 3 108 degree clockwise. The second-degree folded position further reduces the size of the system and can easily enable the multifunctional dual-armed stabilizing system 700 to be put into a portable bag or box. In this position, the upper group of metal folding arms 1 is still attached to the main body of the multifunctional dual-armed stabilizing system 700 via the lower holding shaft 4.

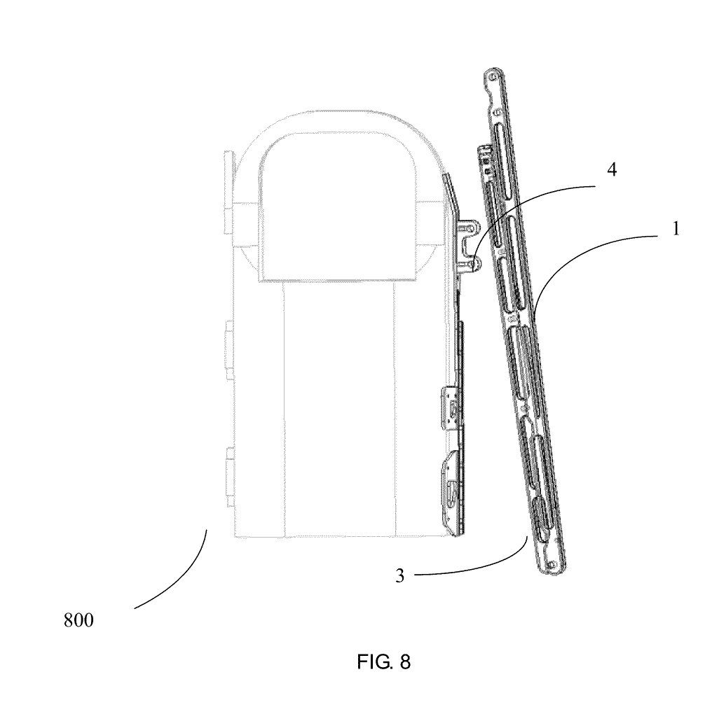

FIG. 8 illustrates a diagram of a multifunctional dual-armed stabilizing system 800 for cameras or video recorders in a third-degree folded position. At the basis of the second-degree folded position, a user can unlock remove the lower holding shaft 4 and separate the upper group of metal folding arms 1 and the lower group of metal folding arms 3 from the main body of the system. The third-degree folded position further reduces the size of the system and makes the whole system more portable.

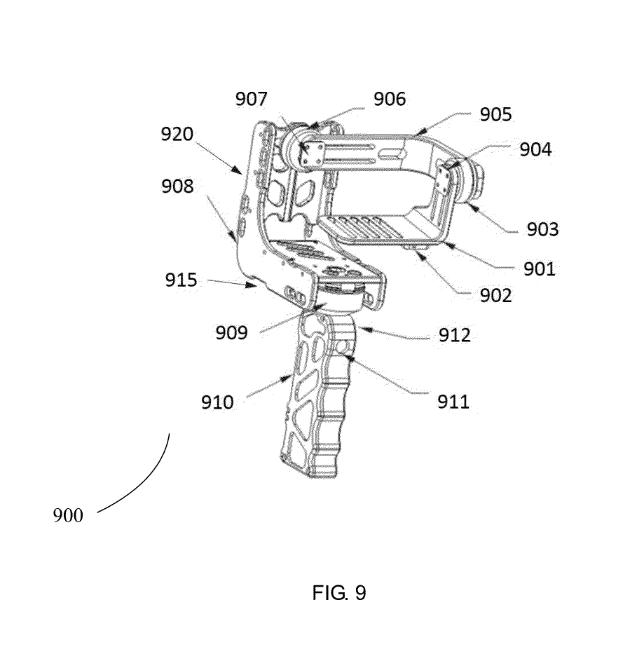

FIG. 9 illustrates a diagram of an electronic gyro stability control system 900 that can be held by a single hand. In some embodiments, the electronic gyro stability control system 900 comprises a grip handle 910 and the grip handle is configured to be held by a single hand. Furthermore, the grip handle comprises a rechargeable battery, a charging jack 911 for the rechargeable battery and a power switch button 912;

In some embodiments, the electronic gyro stability control system 900 comprises a rotation motor 909 coupled to the grip handle 910 and the rotation motor 909 is configured to adjust direction of the electronic gyro stability control system 900.

In some embodiments, the electronic gyro stability control system 900 comprises an L-shaped supporting structure 908 coupled to the rotation motor 909 and controlling circuits sitting within the L-shaped supporting structure 908. The controlling circuits are configured to control the rotation motor 909. The L-shaped supporting structure 908 comprises a first arm 915 and a second arm 920. The first arm 915 of the L-shaped supporting structure is coupled to the rotation motor 909.

In some embodiments, the electronic gyro stability control system 900 comprises a roll motor 906 coupled to the L-shaped supporting structure 908 via the second arm 920 of the L-shaped supporting structure 908. The roll motor 906 is configured to enable adjustments of horizontal position of an installed camera and the controlling circuits are configured to control the roll motor 906.

In some embodiments, the electronic gyro stability control system 900 comprises a roll arm 905 attached to the roll motor 906. The roll arm 905 is driven by the roll motor 906 to stabilize the horizontal position of the installed camera.

In some embodiments, the electronic gyro stability control system 900 comprises a first controller 907 coupled to the roll arm 905. The first controller 907 is configured to stabilize horizontal gravity center of the electronic gyro stability control system 900 with the installed camera.

In some embodiments, the electronic gyro stability control system 900 comprises a tilt motor 903 coupled to the roll arm 905 and the tilt motor 903 is configured to enable adjustments of tilting angle of the installed camera. Furthermore, the tilt motor 903 is configured to stabilize the installed camera within a predetermined tilting angle. The controlling circuits are configured to control the tilt motor 903.

In some embodiments, the electronic gyro stability control system 900 comprises a second controller 904 coupled to the tilt motor 903 and the second controller 904 is configured to stabilize vertical gravity center of the electronic stability control system 900 with the installed camera.

In some embodiments, the electronic gyro stability control system 900 comprises a base plate 901 coupled to the second controller 904 and the base plate 901 is configured to attach the installed camera.

In some embodiments, the electronic gyro stability control system 900 comprises a sensor 902 coupled to the base plate 901 and the sensor 902 sends information of angle and angular acceleration of the installed camera to the controlling circuits. Moreover, the controlling circuits dynamically controls the rotation motor 909, the roll motor 906 and the tilt motor 903 to realize stability of electronic gyro stability control system 900 with the installed camera.

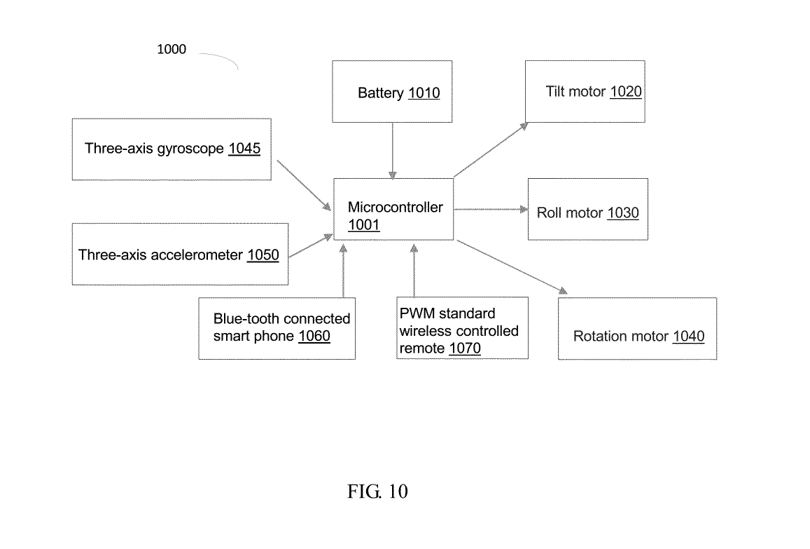

FIG. 10 illustrates a block diagram 1000 illustrating an example of components and their interactions in an electronic gyro stability control system that can be held by a single hand. In some embodiments, three-axis gyroscope 1045 and three-axis accelerometer 1050 obtain the camera angle and angular rotation information and sent the information to the micro-controller 1001. Then, the micro-controller 1001 works under pre-loaded control programs, along with information received from three-axis gyroscope 1045 and three-axis accelerometer 1050 as well as commands from a blue-tooth connected smart phone 1060 or a PWM standard wireless controlled remote 1070. The micro-controller 1001 then controls tilt motor 1020, roll motor 1030 and rotation motor 1040 to stabilize the platform with installed camera. Battery 1010 supplies energy to the microcontroller 1001 and all the motors. Through this design, the electronic gyro stability control system can actively keep the whole platform stable.

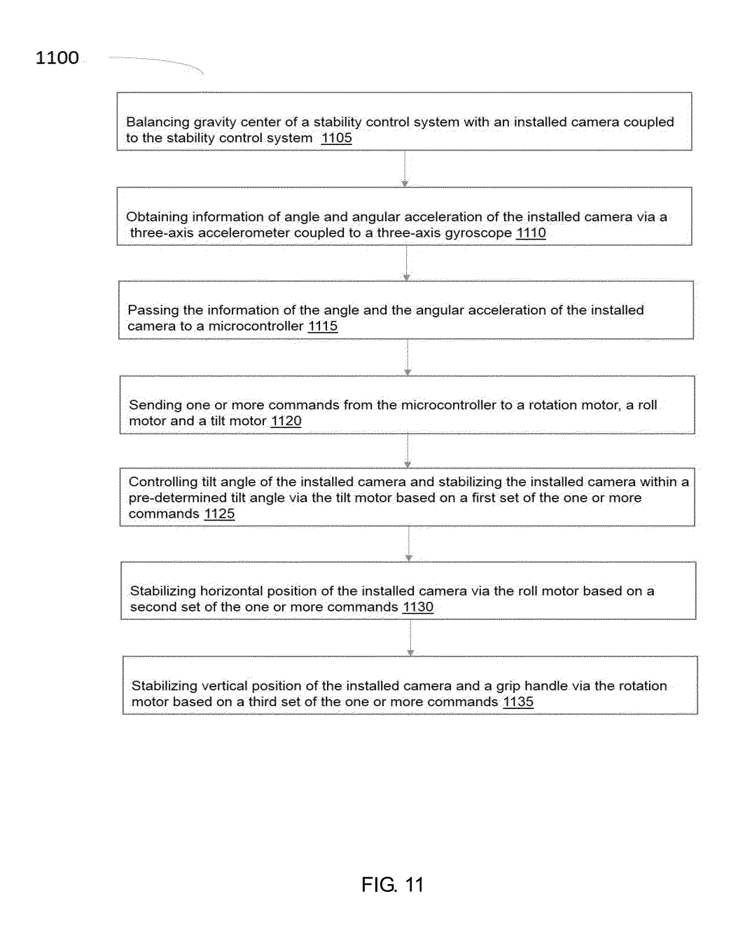

FIG. 11 illustrates a flow diagram 1100 illustrating an example process of dynamically stabilizing a camera. The method comprises several steps. In some embodiments, the method comprises a step 1105 of balancing gravity center of a stability control system with an installed camera coupled to the stability control system.

In some embodiments, the method comprises a step 1110 of obtaining information of angle and angular acceleration of the installed camera via a three-axis accelerometer coupled to a three-axis gyroscope.

In some embodiments, the method comprises a step 1115 of passing the information of the angle and the angular acceleration of the installed camera to a microcontroller.

In some embodiments, the method comprises a step 1120 of sending one or more commands from microcontroller to a rotation motor, a roll motor and a tilt motor. The commands are sent via wireless connections. The one or more commands are determined by the microcontroller based on the information of the angle and the angular acceleration of the installed camera and pre-determined programs stored in the microcontroller.

In some embodiments, the method comprises a step 1125 of controlling tilt angle of the installed camera and stabilizing the installed camera within a pre-determined tilt angle via the tilt motor based on a first set of the one or more commands.

In some embodiments, the method comprises a step 1130 of stabilizing horizontal position of the installed camera via the roll motor based on a second set of the one or more commands.

In some embodiments, the method comprises a step 1135 of stabilizing vertical position of the installed camera and a grip handle via the rotation motor based on a third set of the one or more commands.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for”.) Accordingly, the applicant reserves the right to add additional claims after filing the application to pursue such additional claim forms for other aspects of the disclosure.

1. A multi-functional apparatus, comprising:
a nylon surface sponge cushioning vest, wherein the nylon surface sponge cushioning vest comprises an adjustable shoulder belt, an adjustable chest belt, an adjustable waist belt;
a lower metal panel coupled to the nylon surface sponge cushioning vest, wherein the lower metal panel covers at least a portion of a user's waist;
a metal height adjustment plate coupled to the nylon surface sponge cushioning vest;
an upper metal panel coupled to the nylon surface sponge cushioning vest, wherein the upper metal panel covers at least a portion of the user's back;
a metal folding arms mount coupled to the nylon surface sponge cushioning vest;
a lower group of metal folding arms coupled to the metal folding arm mount via a lower holding shaft, wherein the lower group of metal folding arms comprises two folding arms, wherein a metal limiting panel coupled between the two folding arms; and
an upper group of metal folding arms, coupled to the lower group of metal folding arms via an upper folding shaft, wherein the upper group of metal folding arms comprises another two metal folding arms, wherein the another two metal folding arms comprises at least two sling installation modules.

2. The multi-functional apparatus of claim 1, further comprising:
a first sang, wherein the first sling is connected to a first sling installation module of the at least two sling installation modules via a first metal locking mechanism; and
a second sling, wherein the second sling is connected to a second sling installation module of the at least two sling installation modules via a second metal locking mechanism.

3. The multi-functional apparatus of claim 2, wherein the first sling and the second sling are configured to be elastic, wherein the first sling and the second sling can be nylon ropes or metal spring ropes.

4. The multi-functional apparatus of claim 2, wherein the upper group of metal folding arms comprises a microphone and an installation module for a lamp, wherein the installation module comprises multiple installation holes, wherein camera accessories and extension brackets can be installed on the installation module, pending on needs from a user.

5. The multi-functional apparatus of claim 2, wherein the first sling comprises a metal hook and a metal hook locking mechanism.

6. The multi-functional apparatus of claim 5, wherein the metal hook comprises a hook safety lock.

7. The multi-functional apparatus of claim 1, wherein the upper group of metal folding arms is configured to rotate 270 degrees in a clockwise direction via the at least one folding shaft to form a uniformed structure with the lower group of metal folding arms.

8. The multi-functional apparatus of claim 6, wherein the first sling and the second sling are made of rubber or nylon or a metallic material, wherein the first sling and the second sling are configured to suspend objects.

9. The multi-functional apparatus of claim 1, wherein the lower folding shaft is configured to be removable.

10. The multi-functional apparatus of claim 1, wherein the multi-functional apparatus is configured to hold a video camera.

11. An electronic gyro stability control system, comprising:
a grip handle, wherein the grip handle is configured to be held by a single hand, wherein the grip handle comprises a rechargeable battery, a charging jack for the rechargeable battery and a power switch button;
a rotation motor coupled to the grip handle, wherein the rotation motor is configured to adjust direction of the electronic gyro stability control system;
an L-shaped supporting structure coupled to the rotation motor, wherein controlling circuits sit within the L-shaped supporting structure, wherein the controlling circuits are configured to control the rotation motor, wherein the L-shaped supporting structure comprises a first arm and a second arm, wherein the first arm of the L-shaped supporting structure is coupled to the rotation motor;
a roll motor coupled to the L-shaped supporting structure via the second arm of the L-shaped supporting structure, wherein the roll motor is configured to enable adjustments of horizontal position of an installed camera, wherein the controlling circuits are configured to control the roll motor;
a roll arm attached to the roll motor, wherein the roll arm is driven by the roll motor to stabilize the horizontal position of the installed camera;
a first controller coupled to the roll arm, wherein the first controller is configured to stabilize horizontal gravity center of the electronic stability control system with the installed camera;
a tilt motor coupled to the roll arm, wherein the tilt motor is configured to enable adjustments of tilting angle of the installed camera, wherein the tilt motor is configured to stabilize the installed camera within a predetermined tilting angle, wherein the controlling circuits are configured to control the tilt motor;
a second controller coupled to the tilt motor, wherein the second controller is configured to stabilize vertical gravity center of the electronic stability control system with the installed camera;
a base plate coupled to the second controller, wherein the base plate is configured to attach the installed camera; and
a sensor coupled to the base plate, wherein the sensor sends information of angle and angular acceleration of the installed camera to the controlling circuits, wherein the controlling circuits dynamically controls the rotation motor, the roll motor and the tilt motor to realize stability of electronic gyro stability control system with the installed camera.

12. The electronic gyro stability control system of claim 11, wherein the grip handle is configured to be held upright or be held downwards.

13. The electronic gyro stability control system of claim 11, wherein parameters of the controlling circuits are configured by a smart phone, a remote device or a computer with operation system via bluetooth connections, wherein the computer is configured to have software that is configured to adjust parameters of the controlling circuits.

14. The electronic gyro stability control system of claim 11, wherein the controlling circuits are configured to realize 0.02 degree of rotation angle precision.

15. A method of dynamically stabilizing a camera, comprising:
balancing gravity center of a stability control system with an installed camera coupled to the stability control system;
obtaining information of angle and angular acceleration of the installed camera via a three-axis accelerometer coupled to a three-axis gyroscope;
passing the information of the angle and the angular acceleration of the installed camera to a microcontroller;
sending one or more commands from the microcontroller to a rotation motor, a roll motor and a tilt motor, wherein the commands are sent via wireless connections, wherein the one or more commands are determined by the microcontroller based on the information of the angle and the angular acceleration of the installed camera and pre-determined programs stored in the microcontroller;
controlling tilt angle of the installed camera and stabilizing the installed camera within a pre-determined tilt angle via the tilt motor based on a first set of the one or more commands;
stabilizing horizontal position of the installed camera via the roll motor based on a second set of the one or more commands; and
stabilizing vertical position of the installed camera and a grip handle via the rotation motor based on a third set of the one or more commands, wherein the grip handle is configured to be held by a single hand, wherein the grip handle comprises a rechargeable battery, a charging jack for the rechargeable battery and a power switch button.

16. The method of dynamically stabilizing a camera of claim 15, wherein the rotation motor is configured to keep the installed camera stable within a pre-determined angle.

17. The method of dynamically stabilizing a camera of claim 16, wherein the pre-determined angle is any angle between twelve degrees to fifteen degrees.

18. The method of dynamically stabilizing a camera of claim 15, further comprising:
adjusting parameters of the pre-determined programs via a smart device and wireless connections.

19. The method of dynamically stabilizing a camera of claim 18, wherein the smart device is a smart phone powered by an android operating system or an iOS operating system.

20. The method of dynamically stabilizing a camera of claim 15, wherein the installed camera is fixed by a spring clip coupled to the stability control system.
